(19) United States
(12) Patent Application Publication
(10) Pub. No.: US 2020/0359660 A1
(43) Pub. Date: Nov. 19, 2020

(54) SYSTEMS AND METHODS FOR ENZYMATIC OXYGEN REMOVAL

(71) Applicant: SILVER BEAR, INC., Lake Linden, MI (US)

(72) Inventors: Wilbur H. Campbell, Lake Linden, MI (US); Ellen R. Campbell, Lake Linden, MI (US)

(21) Appl. No.: 16/966,388

(22) PCT Filed: Jan. 31, 2019
(86) PCT No.: PCT/US2019/016106

§ 371 Date: Jul. 30, 2020

Related U.S. Application Data
(60) Provisional application No. 62/624,290, filed on Jan. 31, 2018.

(51) Int. Cl. A23L 3/3571; A23B 7/155; A23L 3/3436; A23L 2/42; B65D 81/26; B65D 65/46

(52) U.S. Cl. CPC A23L 3/3571; A23B 7/155; A23L 3/3436; A23V 2002/00; B65D 81/266; B65D 65/466; A23L 2/42

(57) ABSTRACT

Systems and methods for packing solutions for oxygen-sensitive articles such as food, beverages, and pharmaceuticals, as well as biological samples and/or cultures are disclosed. In preferred systems and methods, oxygen is removed using a bi-enzymatic reaction sequence that recycles and depletes oxygen to extinction, preferably using an oxidase and a catalase as catalysts and a carbohydrate as co-substrate while at least one the enzymes is in a hydrogel or other polymeric formulation.

This application claims priority to our copending U.S. provisional patent application with the Ser. No. 62/624,290, filed Jan. 31, 2018, incorporated by reference herein in its entirety.

### FIELD OF THE INVENTION

The present application relates to packaging systems, compositions, and methods for removal of O₂ (molecular oxygen) from various environments, and especially continuous O₂ removal from void volumes in packaging and even enclosed solid and liquid matter.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Inclusion or ingress of atmospheric molecular oxygen (O₂) into a packaging system is a longstanding problem, particularly where the packaged product is a food item, a beverage, or a pharmaceutical product that is sensitive to atmospheric molecular oxygen. To reduce the oxidation of such products, one or more antioxidants may be included in the product and/or the product may be packaged under an inert gas cover. However, such protective mechanisms are often insufficient, especially where the packing material is a polymeric film or container that will allow gas exchange over time.

To reduce problems associated with O₂ ingress through a polymeric film/container to at least some degree, certain oxygen scavengers or absorbers can be added to the packing or included into the film/container (e.g., AGELESS™, reduced iron salts, from Mitsubishi Gas Chemical). In many cases, the scavengers or absorbers will include high-surface iron powder that will act as a sacrificial material. While effective, use of such scavengers is often not possible in liquid environment. Moreover, the oxygen scavenging capacity of such materials is generally limited. More recently, polymer films that contain a photosensitizing dye and a singlet-oxygen acceptor were developed, which are activated upon illumination. In such products, oxygen is continuously scavenged as a function of lux intensity and available acceptor material. Alternatively, unsaturated hydrocarbons in plastic films can be used as a sacrificial material for oxygen consumption. In still other known instances, sulfites or boric acid in a sachet can be used, while in other systems various sugar alcohols and glycols were employed as antioxidants. In more exotic systems, hydrogen and a palladium catalyst were used to reduce oxidizing/oxidized species. Unfortunately, most of such systems fail to present a viable packing option for fresh produce and/or beverages in plastic containers.

In still further aspects of oxygen removal, glucose oxidase as an enzymatic catalyst has been used in certain circumstances as described, for example, in U.S. Pat. No. 2,482,724. However, such system will rely on the presence and proper distribution of intrinsic, and more typically extraneously added substrates, and suitable enzyme in sufficient quantities throughout the product (e.g., beer, milk, juice), which may adversely affect the product composition and/or organoleptic properties. Similarly, WO 96/40935 teaches use of a hexose oxidase as oxygen removal catalyst in combination with a food item. To circumvent addition of enzyme(s) and substrate to the packaged item, a packing material may be employed as is described in EP 0 595 800. Here, the packing material is a laminate of different plastic layers in which two gas permeable plastic layers enclose a liquid compartment that contains an enzyme system (e.g., oxidases, oxygenases, hydroxylases). Unfortunately, such systems are often prone to fail due to mechanical stress or rupture, and loss of integrity of the laminate will lead to reduced or abolished O₂ scavenging capacity.

Additionally, while enzymatic oxygen removal will provide at least some advantages, various significant difficulties nevertheless arise. Among other things, enzymes are generally sensitive to the ionic strength, pH, and other factors in their environment and tend to quickly denature or otherwise degrade. Moreover, the reaction products of such enzymes is typically an aldehyde (e.g., galactose oxidase forming galactohexodialdose) or a lactone (e.g., glucose oxidase forming glucono-1,5-lactone), which will often undergo further unintended reactions with the packaged food stuff or other goods. Moreover, most enzymatic systems also change the pH, thus significantly changing the chemical environment of the packaged goods or even the pH of the packaged good.

Therefore, even though various systems and methods are known to reduce oxygen in various packaging systems, all or almost all of them suffer from one or more disadvantage. Consequently, there is still a need to provide improved oxygen removal systems suitable for use with packaging materials and/or packaged goods.

### SUMMARY OF THE INVENTION

The inventors have now discovered that various disadvantages of known atmospheric oxygen reduction systems can be overcome using an enzymatic system that not only produces relatively inert reaction products without adverse pH change, but also provides continuous O₂ removal in the headspace of packaged good and even in a liquid product. Most preferably, the enzymatic system is disposed in a polymeric matrix that retains substantially all of the enzymes but allows for sufficient diffusion of substrates and oxygen to so allow protection of an oxygen-sensitive product in a packaging solution. Thus, and viewed from a different perspective, contemplated systems and methods are particularly useful for use with various packaging systems and packaged goods that are sensitive to atmospheric oxygen such as perishable food stuff, pharmaceuticals, electronic components, and even biological samples and cell or tissue cultures.

In one aspect of the inventive subject matter, the inventors contemplate a composition for oxygen depletion that comprises a porous polymeric carrier that includes a pyranose oxidase and a catalase, wherein the polymeric carrier has a pore size sufficient to retain at least some of the pyranose oxidase and the catalase and sufficient to allow ambient oxygen to diffuse to the pyranose oxidase.

In some embodiments, the porous polymeric carrier comprises a hydrogel, which may be formed from a natural and/or synthetic polymer. For example suitable natural polymers may comprise a pectin, hyaluronic acid, an alginic acid, carrageenan, chondroitin sulfate, a dextran sulfate, a chitosan, a poly-lysine, a collagen, a gelatin, carboxymethyl chitin, a cellulose, a fibrin, a dextran, an agarose, and/or a pullulan, while contemplated synthetic polymers may comprise a polyethylene glycol (PEG), a poly(lactic acid) (PLA), a poly(lactic co-glycolic) acid (PLGA), a polycaprolactone (PCL), a polyhydroxybutyrate (PHB), a poly(vinyl alcohol)(PVA), and/or a poly(vinyl acetate)(PVAc). Most typically, but not necessarily, the synthetic polymer has an average pore size of between 2-10 nm.

With respect to the enzymes it is contemplated that the pyranose oxidase has a pH activity range of between pH 5-10 and/or that the catalase has a pH activity range of between pH 3-11. Moreover, it is contemplated that the pyranose oxidase is present in the carrier at a concentration of at least 0.3 U/mL (or gram) of polymeric carrier, and/or wherein the catalase is present at a concentration of at least 0.5 U/mL (or gram) of polymeric carrier. Additionally, it should be noted that the ambient oxygen may be dissolved and/or gaseous oxygen, which is typically in the headspace above a packaged item within a closed container.

Where desired, contemplated compositions may further comprise an oxidase substrate (e.g., D-glucose, D-xylose, D-glucono-1,5-lactone, etc.). In still further embodiments, the porous polymeric carrier may be further enclosed in a liquid and gas permeable enclosure, or the porous polymeric carrier forms part of, or is coupled to a food tray, a packing foil, or a bottle cap.

Therefore, the inventors also contemplate a method of reducing oxygen in a closed package. Such methods will preferably comprise a step of including into the closed package a porous polymeric carrier that includes a pyranose oxidase and a catalase, wherein the polymeric carrier has a pore size sufficient to retain at least some of the pyranose oxidase and the catalase and sufficient to allow ambient oxygen to diffuse to the pyranose oxidase. In another step, the oxidase in the porous polymeric carrier is used to produce from an oxidase substrate and oxygen diffusing into the porous polymeric carrier a reaction product and hydrogen peroxide, and the catalase in the porous polymeric carrier is used to destroy the hydrogen peroxide. Most typically, the oxidase and the catalase are used in the closed package for a time sufficient to reduce the oxygen contained in the closed package.

While not limiting to the inventive subject matter, the oxygen in the closed package is gaseous oxygen in a void space between the package and an item in the closed package, and/or dissolved oxygen in a liquid contained in the package. Therefore, contemplated packages especially include food containers and beverage containers.

While the polymeric carrier may further comprise the oxidase substrate, it should also be appreciated that the food item or beverage enclosed in the closed package may provide at least some of the oxidase substrate. As noted above, it is contemplated that the porous polymeric carrier comprises a hydrogel. In some aspects, the porous polymeric carrier comprises a natural polymer (e.g., a pectin, hyaluronic acid, an alginic acid, carrageenan, chondroitin sulfate, a dextran sulfate, a chitosan, a poly-lysine, a collagen, a gelatin, carboxymethyl chitin, a cellulose, a fibrin, a dextran, an agarose, and/or a pullulan), while in other aspects the porous polymeric carrier comprises a synthetic polymer (e.g., a polyethylene glycol (PEG), a poly(lactic acid) (PLA), a poly(lactic co-glycolic) acid (PLGA), a polycaprolactone (PCL), a polyhydroxybutyrate (PHB), a poly(vinyl alcohol)(PVA), and/or a poly(vinyl acetate)(PVAc)). Similarly, it is generally preferred that the synthetic polymer has an average pore size of between 2-10 nm, that the pyranose oxidase has a pH activity range of between pH 5-10 and/or that the catalase has a pH activity range of between pH 3-11.

Most typically, the oxygen may be reduced under refrigeration (e.g., at a temperature of between 2-8° C.) or at about ambient temperature (e.g., at a temperature of about 20° C.). Therefore, the pyranose oxidase is present in the polymeric carrier at a concentration of at least 0.3 U/mL (or gram) of polymeric carrier, and/or wherein the catalase is present at a concentration of at least 0.5 U/mL (or gram) of polymeric carrier. It is still further contemplated that the porous polymeric carrier is further enclosed in a liquid and gas permeable enclosure, and/or that the porous polymeric carrier forms part of, or is coupled to the closed package. For example, suitable closed packages include food trays, packing foils, and bottle caps. Consequently, the closed package may enclose a food item, a beverage, a pharmaceutical, electronic components, or a biological culture of an anaerobic or microaerobic organism. Most typically, the oxidase and the catalase are used in the closed package over a period of at least 12 hours.

Therefore, and viewed from a different perspective, the inventors also contemplate a container that comprises an oxygen-sensitive article and a porous polymeric carrier that includes a pyranose oxidase and a catalase, wherein the polymeric carrier has a pore size sufficient to retain at least some of the pyranose oxidase and the catalase and sufficient to allow ambient oxygen to diffuse to the pyranose oxidase. Moreover, the porous polymeric carrier and/or the oxygen-sensitive article may further comprise an oxidase substrate such as D-glucose, D-xylose, and/or D-glucono-1,5-lactone.

In some embodiments, the porous polymeric carrier forms part of, or is coupled to the container. Thus, suitable containers include polymeric beverage container, polymeric food tray, and cardboard boxes. In addition, it is generally preferred that at least the porous polymeric carrier is biodegradable, recyclable, or compostable.

In still further aspects of the inventive subject matter, the inventors also contemplate a kit that comprises a food item in combination with an enzymatic system, wherein the enzymatic system is disposed in a porous polymeric carrier that includes a pyranose oxidase and a catalase. Most typically, the enzymatic system, when contained in a closed package together with the food item, reduces the oxygen content in a void space within the closed package or in the food item to so extend a shelf life of the food item by at least one week as compared to the same food item and closed package without the enzymatic system.

For example, suitable food items include various fruits, vegetables, meat products, and a seafood items. Alternatively, the food item may also be is a beverage (e.g., fruit juice, milk product, flavored drink, flavor concentrate, beer, etc.). As noted above, it is contemplated that the porous polymeric carrier may form forms part of or is coupled to the container. Moreover, the porous polymeric carrier and/or the food item may further include an oxidase substrate (e.g., D-glucose, D-xylose, and/or D-glucono-1,5-lactone).

Therefore, the inventors also contemplate the use of a porous polymeric carrier that includes a pyranose oxidase and a catalase to scavenge oxygen from an oxygen-sensitive article and/or a void space within a closed container enclosing the oxygen-sensitive article, wherein the polymeric carrier has a pore size sufficient to retain at least some of the pyranose oxidase and the catalase and sufficient to allow ambient oxygen to diffuse to the pyranose oxidase.

As noted above, the porous polymeric carrier may comprise a hydrogel, a natural polymer (e.g., a pectin, hyaluronic acid, an alginic acid, carrageenan, chondroitin sulfate, a dextran sulfate, a chitosan, a poly-lysine, a collagen, a gelatin, carboxymethyl chitin, a cellulose, a fibrin, a dextran, an agarose, and/or a pullulan), and/or a synthetic polymer (e.g., a polyethylene glycol (PEG), a poly(lactic acid) (PLA), a poly(lactic co-glycolic) acid (PLGA), a polycaprolactone (PCL), a polyhydroxybutyrate (PHB), a poly(vinyl alcohol)(PVA), and/or a poly(vinyl acetate)(PVAc)). Most typically, the synthetic polymer will have an average pore size of between 2-10 nm, and/or the pyranose oxidase has a pH activity range of between pH 5-10 and/or the catalase has a pH activity range of between pH 3-11. Preferably, the pyranose oxidase is present at a concentration of at least 0.3 U/mL of polymeric carrier, and/or the catalase is present at a concentration of at least 0.5 U/mL of polymeric carrier. Where desired, the porous polymeric carrier may further comprise an oxidase (e.g., D-glucose, D-xylose, D-glucono-1,5-lactone, etc.).

Various objects, features, aspects and advantages of the present invention will become more apparent from the following detailed description of various preferred embodiments of the invention along with the accompanying drawing.

### BRIEF DESCRIPTION OF THE DRAWING

FIG. 1 is an exemplary reaction scheme illustrating various aspects of contemplated enzymatic oxygen removal systems according to the inventive subject matter.

FIG. 2 comparatively illustrates various enzymatic reactions and reaction products of contemplated enzymatic oxygen removal systems according to the inventive subject matter.

FIGS. 3A-3B are graphs depicting dissolved oxygen removal in a solution of 0.1 M glucose at room temperature according to the inventive subject matter.

FIG. 4 is a graph depicting dissolved oxygen removal in commercial apple juice at room temperature according to the inventive subject matter.

FIG. 5 is a graph depicting dissolved oxygen removal in commercial beer at room temperature according to the inventive subject matter.

FIGS. 6A-6D show various pictures comparing the status of various fruit slices with and without enzymatic oxygen removal enzymes present during storage at room temperature.

### DETAILED DESCRIPTION

The inventors have now discovered that atmospheric and/or dissolved oxygen (O₂) can be removed from various goods, and especially from packaged goods such as beverages and perishable food items in a conceptually simple and effective manner that can not only deplete the goods and/or any void space between the goods and the packaging material from oxygen, but also in a manner that uses substrates that exhibit little to no interference and/or chemical side reactions. Moreover, contemplated systems and methods allow for separation of the oxygen depleting system from the packaged goods, preferably by inclusion into a polymeric carrier (e.g., hydrogel) without substantially compromising rate or effectiveness of oxygen removal over a large range of pH, osmolarity, temperature, and goods. Indeed, it should be noted that the systems and methods presented herein are especially advantageous where the packaged goods will require different form factors for the oxygen removal system as the oxygen removal system can form part of the packaging system or be easily coupled to the packaging system in various configurations.

Notably, using systems and methods presented herein, oxygen can be removed from an aqueous solution to a level not detectable by electrochemical analysis when the reaction of an aldohexose with oxygen is catalyzed by the corresponding oxidase yielding hydrogen peroxide, which is subsequently disproportionated into water and oxygen catalyzed by a catalase. Likewise, oxygen can also be removed from the headspace of sealed packages to non-detectable levels (using quenched phosphorescence detection).

For example, in especially preferred aspects of the inventive subject matter, reduction and/or elimination of oxygen is carried out in a bi-enzymatic system that uses oxygen and an aldohexose as substrates to generate an oxidized carbohydrate and hydrogen peroxide, which is then converted to water and oxygen in a disproportionation reaction catalyzed by catalase. The so produced oxygen is then eliminated by the aldohexose. Remarkably, as the catalase catalyzes the disproportionation of hydrogen peroxide at significantly faster rates that the aldohexose reductase produces hydrogen peroxide, most if not all adverse effects of the hydrogen peroxide on any packaged goods are negligible, and the hydrogen peroxide will be reduced while still present in the polymeric carrier. Moreover, as the oxygen produced by the catalase is recycled into the bi-enzymatic process, the solution can substantially be driven to oxygen exhaustion.

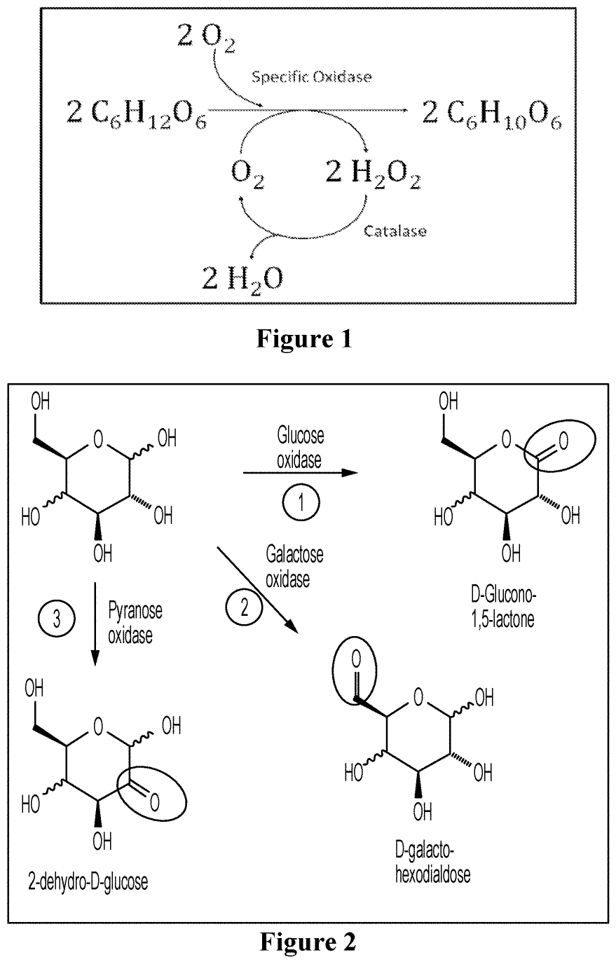

One exemplary schematic overview over a set of bi-enzymatic reactions is illustrated in FIG. 1. Here, two moles of an aldohexose substrate are converted by an aldohexose specific oxidase enzyme in an oxygen consuming reaction to two moles of the corresponding reaction products with concurrent formation of two moles of hydrogen peroxide. A catalase then converts the two moles of hydrogen peroxide to two moles of water and one mole of molecular oxygen, which re-enters the reaction sequence to extinction. Thus, the oxygen in arising from the reaction sequence and/or diffusion to the enzymatic system (e.g., from a gaseous environment or dissolved O₂) can essentially be entirely removed from a closed system. Consequently, a solution and/or gaseous headspace in a package can be maintained in an anaerobic condition. FIG. 2 schematically illustrates exemplary embodiments for the first enzymatic reaction where an aldohexose substrate is converted by an aldohexose specific oxidase enzyme to the corresponding lactone (e.g., via a glucose oxidase in reaction 1), a corresponding sugar aldehyde (e.g., via a galactose oxidase in reaction 2), or a corresponding keto-sugar (e.g., via a pyranose oxidase in reaction 3). Note that only partial reactions are shown omitting oxygen and hydrogen peroxide production. In this context, it should be noted that oxygen removal is facilitated regardless of the particular choice of enzyme and substrate. However, the choice of enzyme and/or substrate will dictate the reaction product, and with the production of a carbohydrate product that may or may not be reactive (e.g., reactive with a packaged good). For example, the reaction of glucose oxidase with glucose will yield glucono-1,5-lactone, which is a known acidifying component in the food industry. Moreover, the lactone group is also reactive with various nucleophilic groups in proteins. Similarly, where the enzyme is galactose oxidase and reacts with galactose, the resulting product is galactohexodialdose, which has a undesirably reactive aldehyde group. On the other hand, where the enzyme is pyranose oxidase, the reaction product is 2-dehydroglucose that is chemically relatively inert. Moreover, the pyranose oxidase reaction will not change the pH of the reaction environment.

As shown in more detail in the Equations I-III below, the reaction of an aldohexose with oxygen is catalyzed by the corresponding oxidase (Equation I). In a second step, the hydrogen peroxide resulting from this reaction is disproportionated into water and molecular oxygen by a catalase (Equation II), and the so generated oxygen are further reduced by the aldohexose. In the net reaction, it should therefore be appreciated that two aldohexose molecules are necessary for the reduction of one oxygen molecule (Equation III), and that the only net reaction products in this sequence besides the oxidized aldohexose is water.

Oxidase Reaction: 2O₂+2C₆H₁₂O₆→2C₆H₁₀O₆+2H₂O₂ Eq. I

Catalase Reaction: 2H₂O₂→O₂+2H₂O Eq. II

Net Reaction: O₂+2C₆H₁₂O₆→2C₆H₁₀O₆+2H₂O Eq. III

Viewed from another perspective, it should be recognized that the use of relatively inert aldohexoses as reducing agents for oxygen advantageously allows such reactions to occur using substrates that are exogenously added or that are already present in the packaged good, particularly where the packaged goods are fruit or vegetables. However, it should be appreciated that the substrate may also be added to the system as an external reagent, either to the packaged good or the polymeric carrier. Advantageously, the substrates are GRAS (generally regarded as safe) and should so allow use of the oxygen removal system with a wide variety of food items, electronic components, pharmaceutical items, and even anaerobic microbial cultures and/or samples.

In this context, it should be appreciated that the three different oxidase enzymes shown in FIG. 2 (glucose oxidase, galactose oxidase, and pyranose oxidase) each catalyze the oxidation of a different hydroxyl group of the aldohexose. For example, glucose oxidase catalyzes the oxidation of the hemi-acetal of glucose to the corresponding lactone, which in water tends to hydrolyze to glucuronic acid, thus acidifying the reaction mixture as oxygen is removed. On the other hand, galactose oxidase catalyzes the reaction of the primary alcohol in galactose to the corresponding aldehyde, which is a reactive molecule with the capacity to inactivate some enzymes by reactions with amine-containing amino acid side chains in the polypeptide backbone of the enzyme. In yet another especially preferred example, pyranose oxidase catalyzes the oxidation of a secondary alcohol of glucose to the respective ketone, which is a relatively non-reactive product. Therefore, it should be recognized that oxygen removal systems and methods can be formulated that are compatible with a large variety of packaged goods, and especially liquid goods (e.g., fruit juice, wine, beer, etc.), fish, meat, and other fatty food items subject to lipid oxidation, and fruit and vegetables subject to phenolic oxidation and other undesirable oxidative processes.

Notably, the inventors have previously used contemplated systems and methods for the removal of oxygen in certain electrochemical sensors in relatively small volumes (e.g., typically volumes of less than 5 ml), and/or in situations where a test medium had a ratio of surface to volume of at least 0.5 cm⁻¹, more typically at least 1 cm⁻¹, and most typically at least 2 cm⁻¹. Notably, the inventors now discovered that these systems and methods, and especially pyranose oxidase-type system are also well suitable for larger liquid and void volumes that are commonly encountered with food packaging. Moreover, the inventors discovered that the enzymes used here (and particularly pyranose oxidase) had sufficient chemical stability and retained enzymatic activity over a relatively wide pH (and osmolarity) range, and could be used in various beverages even when in direct contact with the beverage. Unexpectedly, contemplated systems and methods also performed very well in systems where the enzymes were present in a liquid or semi-liquid phase (e.g., a polymeric carrier, hydrogel, or other containment with semipermeable membrane such as a dialysis bag) to reduce oxygen in a gaseous void volume of a food package.

In exemplary preferred aspects of the inventive subject matter, it is contemplated that the enzymes (e.g., pyranose oxidase and catalase) are disposed within a polymeric carrier (e.g., hydrogel) that is then shaped into a specific desirable form factor for a packaging (e.g., sphere, sheet, block, etc.). Of course it should be recognized that the so formed hydrogel can be further enclosed into a rigid or flexible enclosure that is liquid and gas permeable. For example, where the enclosure should be flexible and can be in contact with a packaged good, suitable enclosures include an absorbent cloth or gauze package or laminate. On the other hand, where a rigid enclosure is desired, a plastic case or cage with pores, channels, or other openings is contemplated. In yet other aspects, the polymeric carrier can also be configured as a thin sheet that is disposed between the thin plastic layers that are at least permeable to O₂ to form a laminate where one side of the laminate is further coupled to a gas impermeable (or less permeable) plastic film. Therefore, it should be appreciated that the polymeric carrier may be disposed in a package or packaged good (e.g., where the carrier is in a hydrogel that is in a liquid), coupled to a package enclosing the goods (e.g., in an enclosure that is liquid and gas permeable), or may form part of the packaging material (e.g., where the polymeric carrier is part of a packaging film).

Therefore, and viewed form a different perspective, polymeric carriers will provide at least one enzyme (e.g., pyranose oxidase and/or catalase) and/or a solvent system, and the carrier may be further enclosed with a secondary enclosure that will permit exchange of at least oxygen between the packaging space/packaged goods and the polymeric carrier. As will be readily appreciated, oxygen exchange may be performed through a liquid phase or from a gas phase across the enclosure into the polymeric carrier. Lastly, it is contemplated that the carbohydrate reaction product may also be further degraded by additional enzymatic systems, or used in an indicator reaction (e.g., hydrogen peroxide sensitive dyes such as DAB (3,3-diaminobenzidine), or ABTS (2,2′-azino-bis(3-ethylbenzothiazoline-6-sulphonic acid)).

With respect to suitable polymeric carriers it is preferred that the polymeric carrier is or comprises a hydrogel that encloses at least one enzyme (e.g., pyranose oxidase), and more typically both enzymes (e.g., pyranose oxidase, catalase). Furthermore, it should be noted that the polymeric carrier may be hydrated or at least partially dehydrated (e.g., where the enzyme activation is initiated by contact with water or the enclosed water-containing goods). There are numerous hydrogels and polymeric carriers known in the art, and all of the known hydrogels and polymeric carriers are deemed suitable for use herein (see e.g., “Hydrogels for biomedical applications” Advanced Drug Delivery Reviews 64 (2012) 18-23).

For example, contemplated polymers include natural polymers and their derivatives, which may or may not include crosslinkers. Among other options, contemplated polymers can be anionic polymers such as hyaluronic acid, alginic acid, pectin, carrageenan, dextran sulfate, and/or chondroitin sulfate, while cationic polymers include chitosan, polylysine. Suitable amphipathic polymers include collagen (and gelatin), carboxymethyl chitin, fibrin, while contemplated neutral polymers include cellulose (and derivatives thereof), dextran, agarose, and pullulan. Similarly, the polymers for suitable polymeric carriers may also be synthetic polymers such as polyethylene glycol (PEG), poly(lactic acid) (PLA), poly(lactic co-glycolic) acid (PLGA), polycaprolactone (PCL), polyhydroxybutyrate (PHB), poly(vinyl alcohol)(PVA), and/or poly(vinyl acetate)(PVAc) and all reasonable mixtures thereof, which may or may not be crosslinked. For example, mixed polymers include PEG-PLA-PEG, PEG-PLGA-PEG, PEG-PCL-PEG, PLA-PEG-PLA, PHB, P(PF-co-EG)±acrylate end groups, P(PEG/PBO terephthalate), PEG-bis-(PLA-acrylate), PEG±CDs, PEG-g-P(AAm-co-Vamine), PAAm, P(NIPAAm-co-AAc), P(NIPAAm-co-EMA), PVAc/PVA, PNVP, P(MMA-co-HEMA), P(AN-co-allyl sulfonate), P(biscarboxy-phenoxy-phosphazene), and P(GEMAsulfate). Of course, natural and synthetic polymers may also be combined to form P(PEG-co-peptides), alginate-g-(PEO-PPO-PEO), P(PLGA-co-serine), collagen-acrylate, alginate-acrylate, or P(HPMAg-peptide).

Most typically, the pore size of the polymeric carrier will be selected such that the polymeric carrier will retain the enzyme(s) within the polymeric structure while allowing for dissolved and/or atmospheric O₂ to enter the polymeric carrier. The person of ordinary skill in the art will be readily apprised of the suitable pore size by experimental determination of enzyme release from the polymeric carrier using conventional tests for the enzymatic reaction of enzymes released from the carrier, and/or by experimental determination of pore size (e.g., using ingress of fluorescence labeled dextran into the polymeric carrier. Moreover, it should be appreciated that the solvent in the polymeric carrier may be the same of different than the solvent typically found in the packaged (food) product. For example, the solvent in the hydrogel may be a phosphate buffered saline, while the packaged good is apple juice. In yet further contemplated aspects, it is noted that the polymeric carrier need not necessarily have a solvent present, but may be dried or at least partially dehydrated. Therefore, contemplated enzyme systems may be activated upon contact with water or other water containing liquid that may in at least some embodiments originate from the packaged good (e.g., beverage or meat)

In still further contemplated aspects, the polymeric carrier or the enzyme(s) may also be adsorbed onto or bound to fibrous structures, and especially cellulosic fibers and hollow microfibers. For example, the enzymes may be adsorbed onto cellulose or modified cellulose pads that can be in contact with the packaged goods. On the other hand, the fibers may also be further chemically modified with one or more crosslinking groups (e.g., having amino reactive group such as N-hydroxysuccinimide ester group, epoxide group, carbodiimide group, acylazide group, various anhydride groups, etc.) or thiol reactive group such as maleimide groups, haloacetyl groups, pyridyl disulfide group, etc.) that will chemically and covalently bind the enzyme(s) to the fiber. In such case, the polymeric carrier can be configured as a spun or woven fiber product, or as a paper-like product in which the modified fibers are arranged as pulp fibers in the paper-like product.

Similarly, it should be appreciated that the oxygen removal system presented herein is not limited to use in conjunction with a specific oxidase, but that all known oxidases are deemed suitable or use herein. Thus, all enzymes under the EC 1.x.x.x classification are appropriate. Viewed form another perspective, suitable oxidases include those that contain one or more redox active groups bound to an apo-protein of the enzyme, and/or those that can be reduced by a reduced dye as a substitute for the natural electron donor. Therefore, and among other suitable oxidases, especially preferred oxidases include aldohexose oxidases, amine oxidases, amino acid oxidases, aldehyde oxidase, and urate oxidases.

However, it should be recognized that pyranose oxidase is particularly preferred as that enzyme (and its analogs) catalyzes the regioselective oxidation of aldopyranoses at position C2 to the corresponding 2-ketoaldoses and as such does not produce an aldehyde reaction product and will not change the pH in the reaction environment. Viewed from a different perspective, the inventors therefore also contemplate all enzymes that oxidize various other substrates (e.g., D-xylose, L-sorbose, D-glucono-1,5-lactone) having the same ring conformation and configuration at C-2, C-3 and C-4. Consequently, all enzymes (natural or recombinant) belonging to the EC 1.1.3.10 group are particularly preferred for use herein. Therefore, the substrate of the reaction will typically include, inter alia, D-glucose, D-xylose, L-sorbose, and D-glucono-1,5-lactone. Likewise, with respect to the catalase used in conjunction with the teachings presented herein, it should be appreciated that all catalase enzymes are deemed suitable. Thus, all enzymes belonging to the EC 1.11.1.6 class are deemed suitable for use herein.

As will be readily appreciated, suitable enzymes, and particularly pyranose oxidase, may be isolate from various sources, which will at least in part have influence on substrate specificity, optimal pH, pH range, optimal temperature, temperature range, Kₘ value, k_{cat}/Kₘ value, general and storage stability, etc., and the person of ordinary skill in the art will be readily appraised of the suitable choice using publically available information (e.g., URL: brenda-enzymes.org/). Moreover, it should be appreciated that the enzyme can be isolated from organisms growing under specific (extreme) conditions to so further impart thermal stability, high salinity stability, etc. Thus, suitable sources include commonly known sources as well as thermophile, halophile, and extremophile microorganisms. Similarly, it is contemplated that the enzymes used in the systems and methods contemplated herein can be genetically modified to be more resistant to selected pH, salinity, ionic strength, alcohol content, osmotic pressure, etc.

For example, the pyranose oxidase may be recombinant or isolated from an organism that naturally produces the pyranose oxidase, including Aspergillus spec., Polyporus spec., Phanerochaete spec., Trametes spec., etc. Likewise, the catalase may be recombinant or isolated from an organism that naturally produces the catalase, including Aspergillus spec., Bacillus spec., Listeria spec. Bos spec., Oryza spec., etc. Moreover, it should be recognized that the particular choice of enzyme may depend on the desired pH range, thermal stability, and other factors genuine to the oxygen removal system. Suitable sources of enzymes and their respective parameters can be readily identified from publically available sources (e.g., BRENDA, The Comprehensive Enzyme Information System; URL: brenda-enzymes.org). Most typically, the molar ratio of oxidase to catalase will be an equimolar ratio, but various other ratios are also deemed suitable, including ratios of 10:1 to 1:10 (oxidase to catalase).

Depending on the particular use, it should be appreciated that the systems and methods need not necessarily require a catalase as enzyme, and it is noted that where peroxides will be tolerable, oxygen removal can be performed with a pyranose oxidase (or other enzyme) alone. Moreover, it is contemplated that the enzymatic system may be separate from the packaged item or may be admixed or otherwise in intimate contact with the packaged items. For example, where the packaged item is a beverage such as juice or beer, the enzyme(s) may be directly included (admixed) into the beverage. In such case, the beverage will already comprise suitable quantities of pyranose sugars as substrates and will be tolerant to generation of H₂O₂. On the other hand, where the beverage does not include suitable quantities of pyranose sugars as substrates and/or will be intolerant to generation of H₂O₂, the enzymatic system may be contained in a fluidly isolated compartment that will allow for an exchange of oxygen into the isolated compartment.

In view of the above, it should therefore be appreciated that the oxygen removal systems and methods can be employed in a variety of uses, and especially in removal of oxygen and the maintenance of low oxygen levels within packages that enclose food items (solid and liquid), pharmaceutical agents, biological samples, and non-biological items (e.g., electronic components) that are sensitive to the presence of oxygen. Removal of oxygen using contemplated systems and methods is typically to a level at or below 1 vol %, or at or below 0.1 vol %, or at or below 0.01 vol %, or at or below 0.001 vol %. Likewise, where oxygen is dissolved in a liquid, contemplated dissolved oxygen concentrations include those at or below 40 ppm, or at or below 20 ppm, or at or below 10 ppm, or at or below 5 ppm. Thus, oxygen saturations of at or below 50%, or at or below 30%, or at or below 10%, or at or below 5%, are contemplated herein.

Viewed form yet another perspective, oxygen can be removed from an initial oxygen concentration to a reduced concentration, where the reduced oxygen concentration is equal or less than 80%, or equal or less than 70%, or equal or less than 60%, or equal or less than 50%, or equal or less than 40%, or equal or less than 30%, or equal or less than 20%, or equal or less than 10%, or equal or less than 5%, or equal or less than 2% of the original oxygen concentration (which may be atmospheric oxygen or dissolved oxygen). Notably, due to the catalytic nature of the oxygen depletion, such reduction is continuous in an enclosed space for at least 1 day, and more typically for at least 1 week, or at least 2 weeks, or at least 3 weeks, or at least 1 month, or at least two months, and even longer. Therefore, contemplated oxygen removal systems are particularly beneficial in packaging oxygen-sensitive goods where the oxygen is present in the headspace between the packaged good and the packing material and/or where the packaging material is oxygen permeable.

For example, oxygen removal from beverages stored in gas permeable plastic bottles are contemplated in which a bi-enzymatic reaction sequence recycles to deplete oxygen as further described below and maintains oxygen at low levels during storage of the container to preserve freshness, aroma, and flavor of the beverage. Among other beverages, beer, coffee, kombucha, natural juice, tea, wine and the emerging market of flavor concentrates all can have a sensitivity to oxygen. Even carbonated beverages that are known for their fizz as well as their taste can have flavor oils that are oxygen sensitive and degrade over time. Preferred enzymes in such case include an oxidase and a catalase as biocatalysts and a carbohydrate substrate (which may be present in the beverage) as co-substrate. In some aspects, the enzymes are present in an immobilized package in a gas-permeable membrane along with supply of co-substrate; or the membrane selectively allows sugars from the beverage to cross to act as the co-substrate, while in other aspects the substrate may be present as an existing component of the beverage. Therefore, it should be appreciated that in some aspects of the inventive subject matter is concerned with oxygen (O₂) removal systems for preservation of beverages stored in gas permeable plastic bottles (all types of beverages stored in plastic bottles are subject to degradation due to atmospheric oxygen diffusing into the plastic bottle during storage). Among other beverages, especially contemplated beverages include beer, wine, mixed alcoholic drinks, fruit juices, soft drinks, teas, and coffees.

Likewise, it should be noted that suitable packaging need not be limited to a plastic bottle, but contemplated packaging compositions and formats will include all packaging that includes a gas permeable polymer film or other component, and also all packaging that results in a void space due to irregular shapes of the packaged article (e.g., film packing of nuts, meat, or fish on a tray or other container). Moreover, according to the National Institute of Health, oxidation is a common pathway for drug degradation. Medical packaging for devices such as pregnancy test kits, require oxygen barrier to ensure proper performance of the devices. The enzyme oxygen scavenger system presented herein could be incorporated in these types of packaging.

### Examples

For the following examples and other contemplations presented herein, it should be noted that O₂ measurement can be performed following numerous methods known in the art and the particular system will at least in part be dictated by the medium in which O₂ is being measured. Thus, electrochemical sensors and optical sensors (e.g., fluorescence quenching as is used with OXYDOT™ (metal organic fluorescent dye immobilized in a gas permeable hydrophobic polymer, commercially available from Oxysense, New Castle, Del. 19720, US), and other optical methods) are deemed especially suitable for use herein.

Exemplary Enzyme System:

Commercially available pyranose oxidase (Sigma Aldrich P4234) is stored in 25 mM MES/0.1 mM EDTA, pH 7.0; Commercially available catalase (Sigma Aldrich C3515) CatR is stored in 50 mM MOPS/0.1 mM EDTA pH 7.0. Unless otherwise indicated, polymeric carrier was PVA (polyvinyl alcohol) that was prepared with phosphate buffer plus glucose: 25 mM NaPhos pH 7, plus 0.1 M glucose to hydrate the PVA. Enzyme concentration range: PyrOx needs to be greater than 0.3 Units or 0.01 mg active enzyme per mL PVA, and in some examples, the highest concentration was 75 U (1.6 mg) per mL PVA; The minimum quantity for catalase is unknown, but most experiments used between 0.5 U and 5 U (or 0.5 mg) per mL PVA.

Model System for Dissolved Oxygen

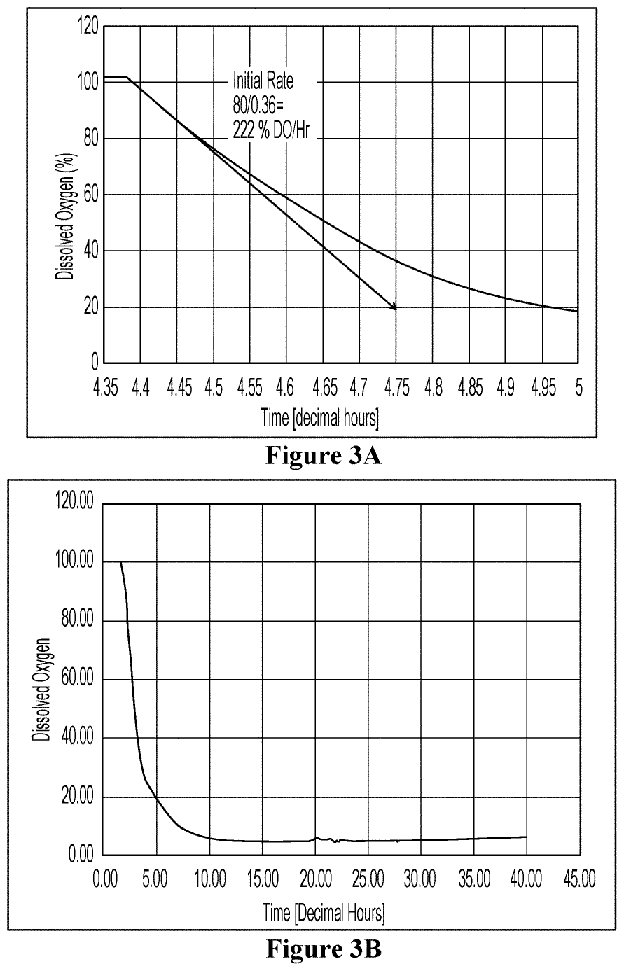

FIGS. 3A and 3B depict the optical sensor time trace of dissolved oxygen removal in a solution of 0.1 M glucose at room temperature (22-24° C.) contained in a 100 mL graduated cylinder with immobilized oxygen removal enzymes present with an Visiferm™ Dissolved Oxygen (DO) probe sealed with Saran™ wrap and Parafilm™. The DO probe was calibrated to 100% DO prior to starting the time of the analysis, after it had been equilibrated in the system. The time trace was obtained with New Brunswick™ BioFlo® 415 Biocommand® software (Eppendorf North America) and exported as an Excel™ file. The polymeric carrier package contained recombinant pyranose-2 oxidase (5.0 units) and recombinant catalase-R (136 units), which were produced by NECi-SE Inc. (URL: nitrate.com). The enzymes were first mixed with a solution of polyvinyl alcohol (PVA, 4 mg per mL) and dried on the wall of a plastic cuvette for 24 hours at 4° C.; and subsequently coated with a layer PEGDGE (2 mg per mL) and dried at room temperature for 4 hours and finally stored at 4° C. FIG. 3A depicts results for a short term experiment (0-5 hours), while FIG. 3B depicts results for a long term experiment (0-40 hours). Clearly, dissolved oxygen was effectively removed.

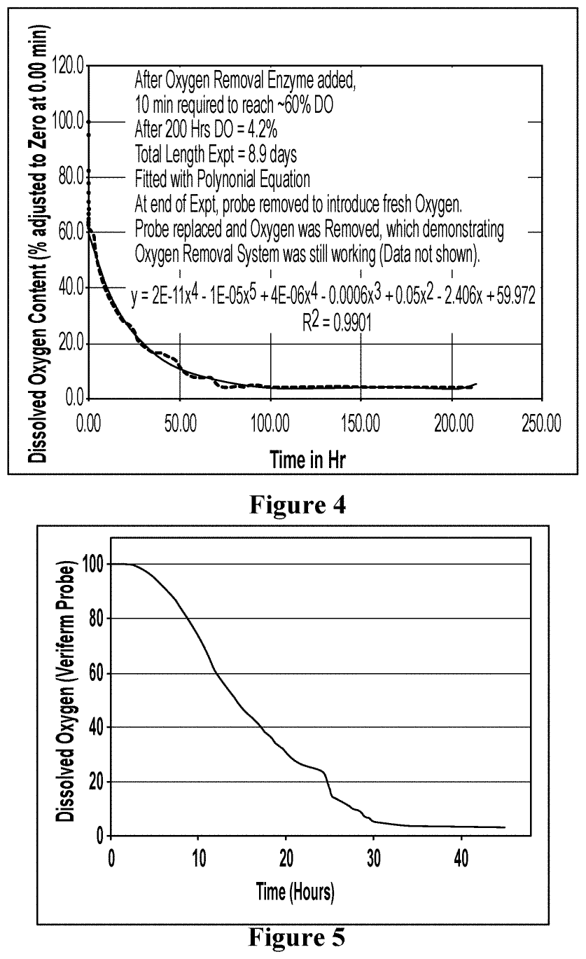

FIG. 4 presents the optical sensor time trace of dissolved oxygen removal in a solution of commercial apple juice at room temperature (22-24° C.) contained in a 100 mL graduated cylinder over >200 hours with immobilized oxygen removal enzymes present as noted above with a Visiferm™ Dissolved Oxygen (DO) probe sealed with Saran™ wrap and Parafilm™ As in the previous experiment, dissolved oxygen was effectively removed.

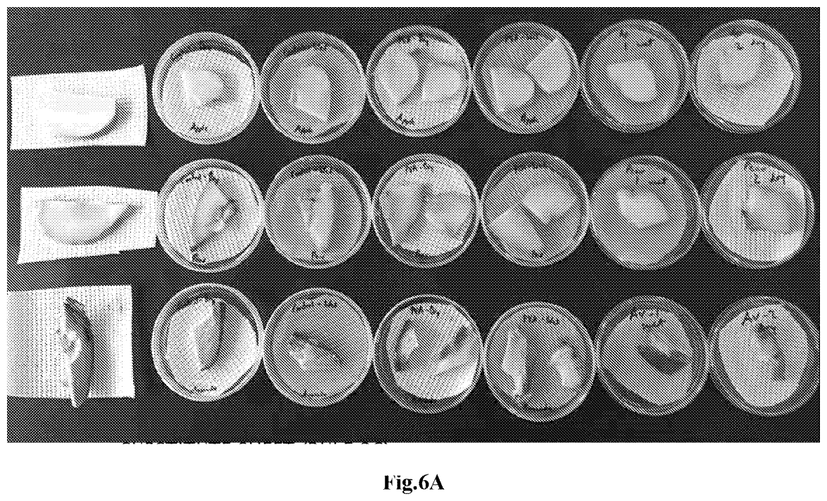

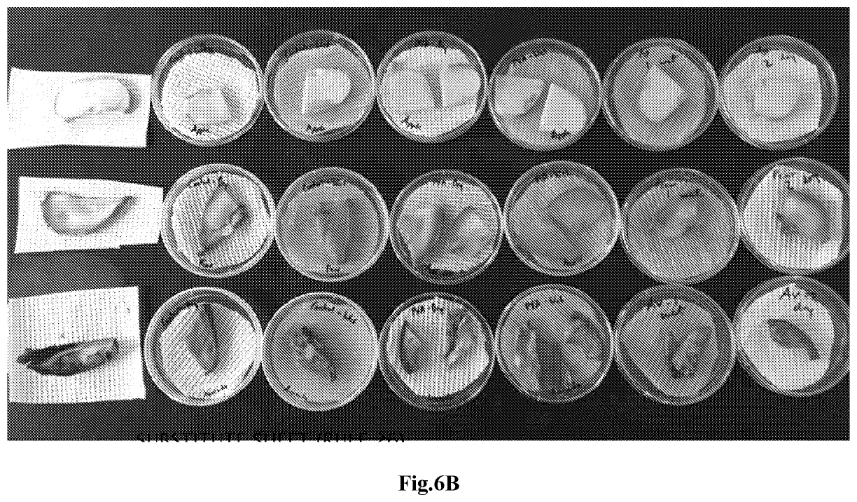

FIG. 5 presents the optical sensor time trace of dissolved oxygen removal in a solution of commercial beer at room temperature (22-24° C.) contained in a 100 mL graduated cylinder with immobilized oxygen removal enzymes present as noted above over >40 hours with an Visiferm™ Dissolved Oxygen (DO) probe sealed with Saran™ wrap and Parafilm™ Here, the PVA-enzyme polymer was prepared using 10 ml beakers as a casting mold, diameter=2.5 cm, thickness=0.3 cm. Polymer was composed of 581 μL 10% PVA, 106 μL P2Ox (56 Units), and 53 tit CatR (429 Units). Freeze/thaw method was used to create hydrogel polymer, freezing lasted 20 min, thawing at RT lasted generally 45 min. Enzyme polymer was stored at room temperature 22-24° C.). Snake-Skin Dialysis Tubing 10k MIA/CO was used, closed with clips, to separate enzyme from solution (ThermoFisher Scientific, Product #68100, Lot #OL193007).

Beer sample was Keweenaw Brewing Company Red Jacket, opened and allowed to equilibrate at room temp, stirred to saturate with oxygen. Poured 100 ml of beer into graduated cylinder and stirred with magnetic stir bar until oxygen saturated. Oxygen levels were measured using a Visiferm DO probe and Biocommand software, calibrated oxygen to 100 before starting experiment. Placed enzyme polymer in dialysis tubing along with 2 ml of beer then closed off tubing with clip. Placed enzyme polymer and tubing in 100 ml of beer and covered with Parafilm™. Slight agitation was applied using a stir bar for the entire experiment. Dissolved Oxygen (OD) levels steadily declined for ˜35 hours and reached final OD of 3.45.

Model System for Oxygen in Headspace

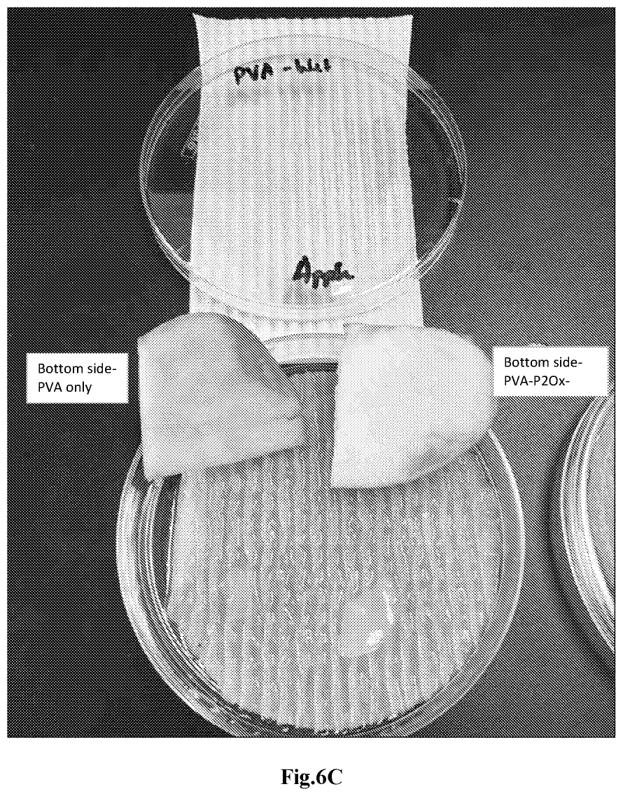

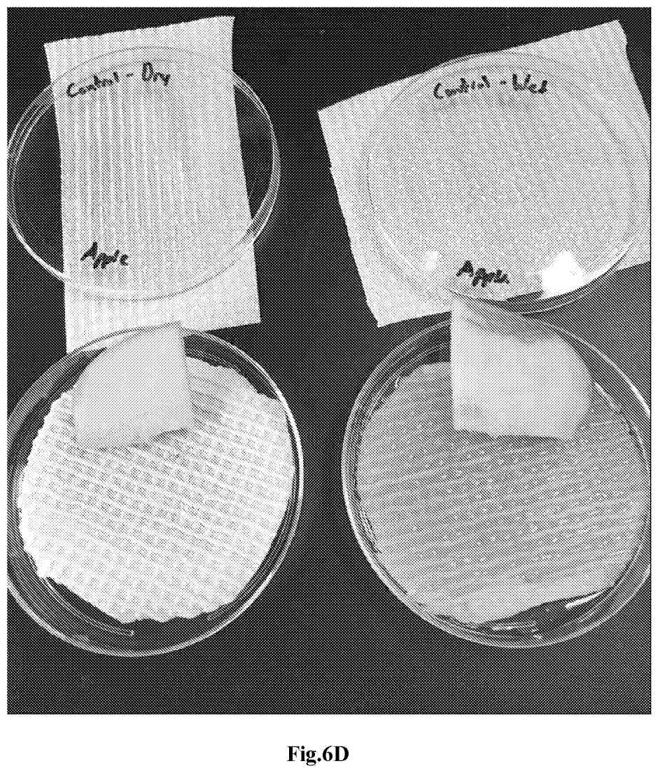

In still further experiments, the inventors tested contemplated systems and methods using various fruit samples as is shown in the set-up of FIG. 6A and evaluation after 24 hours as shown in FIG. 6B. More specifically, and referring to the rows and columns of the samples as shown the samples were set up as follows:

| | Package Sealed | | | Package Open to Air | | |
|---|---|---|---|---|---|---|
| Apple | Control-Dry | Control-wet | PVA/Enzyme- | PVA/Enzyme- | PVA/Enzyme- | PVA/Enzyme- |
| | | | Dry | Wet | Wet | Dry |
| Pear | Control-Dry | Control-wet | PVA/Enzyme- | PVA/Enzyme- | PVA/Enzyme- | PVA/Enzyme- |
| | | | Dry | Wet | Wet | Dry |
| Avocado | Control-Dry | Control-wet | PVA/Enzyme- | PVA/Enzyme- | PVA/Enzyme- | PVA/Enzyme- |
| | | | Dry | Wet | Wet | Dry |

Control: No carrier polymer and enzyme; PVA/Enzyme: 10% PVA polymer on left, and 10% PVA-P2Ox-CatR polymer on right; dry indicates lab mat with no added solution; Wet indicates lab mat with 10 ml 25 mM phosphate buffer pH7.0, 0.1M glucose added solution.

FIG. 6C show exemplary results for apples as indicated with corresponding control group shown in FIG. 6D. As can be readily taken from the Figures, the enzyme system had significant reduction in phenolic browning of the apple, whereas no difference in browning was observed in the control samples.

Model System for Dissolved Oxygen and Oxygen in Headspace

The following experiments were performed using a commercially available drink in sealed vials with 15 ml air in the headspace over 25 ml of the drink. OXYDOT™ were used in both the liquid and the headspace and measurements were taken from the closed containers. Enzymes used were Pyranose 2-Oxidase (P2Ox) and Catalase (CatR) Enzymes; OXYSENSE™ 4000 B (commercially available from Oxysense, New Castle, Del. 19720, US) testing equipment was used with standard GC 40 mL Glass Vials; Control vials were filled with 25 mL of Gatorade and sealed; Enzyme vials contain 25 mL of Gatorade as glucose source and a gel made from 580 μL of a 10% PVA solution in a pH 7.2 phosphate buffer infused with 1064 of enzyme solution P20× and 53 μL of enzyme solution CatR. The gel was immersed in the liquid, and exemplary results are shown in the tables below.

Exp.1 (plus open vial control showed 19.89 O2 in ambient air)

| OxyDot in | | OxyDot in | | OxyDot in | | OxyDot in | |
|---|---|---|---|---|---|---|---|
| Liquid | % Oxygen | Liquid | % Oxygen | Headspace | % Oxygen | Headspace | % Oxygen |
| Control 1 | 17.29 | Enzyme L 1 | 0.01 | Control Headspace 1 | 19.93 | Enzyme H 1 | 14.65 |
| Control 2 | 18.58 | Enzyme L 2 | 0.00 | Control Headspace 2 | 20.53 | Enzyme H 2 | 19.42 |
| Control 3 | 18.38 | Enzyme L 3 | 0.00 | Control Headspace 3 | 20.47 | Enzyme H 3 | 18.52 |
| Control 4 | 17.83 | Enzyme L 4 | 0.00 | Control Headspace 4 | 19.87 | Enzyme H 4 | 17.30 |
| Control 5 | 18.87 | Enzyme L 5 | 0.00 | Control Headspace 5 | 20.68 | Enzyme H 5 | 16.23 |
| Control 6 | 18.89 | Enzyme L 6 | 0.16 | Control Headspace 6 | 19.79 | Enzyme H 6 | 17.30 |
| Average | 18.31 | Average | 0.03 | Average | 20.21 | Average | 17.24 |
| Minimum | 17.29 | Minimum | 0.00 | Minimum | 19.79 | Minimum | 14.65 |
| Maximum | 18.89 | Maximum | 0.16 | Maximum | 20.68 | Maximum | 19.42 |

Exp.2 (plus open vial control showed 20.01 O2 in ambient air)

| OxyDot in | | OxyDot in | | OxyDot in | | OxyDot in | |
|---|---|---|---|---|---|---|---|
| Liquid | % Oxygen | Liquid | % Oxygen | Headspace | % Oxygen | Headspace | % Oxygen |
| Control 1 | 16.66 | Enzyme L 1 | 0.00 | Control Headspace 1 | 19.88 | Enzyme H 1 | 8.36 |
| Control 2 | 19.44 | Enzyme L 2 | 0.00 | Control Headspace 2 | 20.25 | Enzyme H 2 | 12.86 |
| Control 3 | 18.57 | Enzyme L 3 | 0.00 | Control Headspace 3 | 20.11 | Enzyme H 3 | 9.76 |
| Control 4 | 18.74 | Enzyme L 4 | 0.00 | Control Headspace 4 | 19.81 | Enzyme H 4 | 11.43 |
| Control 5 | 18.67 | Enzyme L 5 | 0.00 | Control Headspace 5 | 19.77 | Enzyme H 5 | 11.65 |
| Control 6 | 19.30 | Enzyme L 6 | 0.00 | Control Headspace 6 | 20.02 | Enzyme H 6 | 10.31 |
| Average | 18.56 | Average | 0.00 | Average | 19.97 | Average | 10.73 |
| Minimum | 16.66 | Minimum | 0.00 | Minimum | 19.77 | Minimum | 8.36 |
| Maximum | 19.44 | Maximum | 0.00 | Maximum | 20.25 | Maximum | 12.86 |

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1-15. (canceled)

16. A method of reducing oxygen in a closed package, comprising:
including into the closed package a porous polymeric carrier that is or comprises a hydrogel that includes a pyranose oxidase and a catalase;
wherein the polymeric carrier has a pore size sufficient to retain at least some of the pyranose oxidase and the catalase and sufficient to allow ambient oxygen to diffuse to the pyranose oxidase;
using the oxidase in the porous polymeric carrier to produce from an oxidase substrate and oxygen diffusing into the porous polymeric carrier a reaction product and hydrogen peroxide;
using the catalase in the porous polymeric carrier to reduce the hydrogen peroxide; and
wherein the oxidase and the catalase are used in the closed package for a time sufficient to reduce the oxygen contained in the closed package.

17. The method of claim 16 wherein the oxygen in the closed package is gaseous oxygen in a void space between the package and an item in the closed package.

18. The method of claim 16 wherein the oxygen in the closed package is dissolved oxygen in a liquid contained in the package.

19. The method of claim 16 wherein the package is a food container or a beverage container.

20. The method of claim 16 wherein the polymeric carrier further comprises the oxidase substrate.

21. The method of claim 16 wherein a food item or beverage enclosed in the closed package provides at least some of the oxidase substrate.

22. The method of claim 16 wherein the hydrogel comprises a phosphate buffer.

23. The method of claim 16 wherein the porous polymeric carrier is selected from the group consisting of a pectin, hyaluronic acid, an alginic acid, carrageenan, chondroitin sulfate, a dextran sulfate, a chitosan, a poly-lysine, a collagen, a gelatin, carboxymethyl chitin, a cellulose, a fibrin, a dextran, an agarose, a pullulan, a polyethylene glycol (PEG), a poly(lactic acid) (PLA), a poly(lactic co-glycolic) acid (PLGA), a polycaprolactone (PCL), a polyhydroxybutyrate (PHB), a poly(vinyl alcohol)(PVA), and a poly(vinyl acetate)(PVAc).

24-26. (canceled)

27. The method of claim 16 wherein the porous polymeric carrier has an average pore size of between 2-10 nm.

28. The method of claim 16 wherein the pyranose oxidase has a pH activity range of between pH 5-10 and/or wherein the catalase has a pH activity range of between pH 3-11.

29-30. (canceled)

31. The method of claim 16 wherein the pyranose oxidase is present at a concentration of at least 0.3 U/mL of polymeric carrier, and/or wherein the catalase is present at a concentration of at least 0.5 U/mL of polymeric carrier.

32. The method of claim 16 wherein the closed package encloses a food item, a beverage, a pharmaceutical, or a biological culture of an anaerobic or microaerobic organism.

33. The method of claim 16 wherein the porous polymeric carrier is further enclosed in a liquid and gas permeable enclosure.

34. The method of claim 16 wherein the porous polymeric carrier forms part of or is coupled to the closed package, and wherein the closed package is a food tray, a packing foil, or a bottle cap.

35. The method of claim 16 wherein the oxidase and the catalase are used in the closed package over a period of at least 12 hours.

36. A container, comprising:
an oxygen-sensitive article;
a porous polymeric carrier that is or comprises a hydrogel that includes a pyranose oxidase and a catalase; and
wherein the polymeric carrier has a pore size sufficient to retain at least some of the pyranose oxidase and the catalase and sufficient to allow ambient oxygen to diffuse to the pyranose oxidase.

37. The container of claim 36 wherein the porous polymeric carrier and/or the oxygen-sensitive article further comprises an oxidase substrate selected from the group consisting of D-glucose, D-xylose, and/or D-glucono-1,5-lactone.

38. The container of claim 36 wherein the porous polymeric carrier forms part of or is coupled to the container.

39. The container of claim 36 configured as a polymeric beverage container, a polymeric food tray, or a cardboard box.

40. The container of claim 36 wherein at least the porous polymeric carrier is biodegradable, recyclable, or compostable.

41-55. (canceled)
